(19) United States
(12) Patent Application Publication
(10) Pub. No.: US 2006/0134382 A1
(43) Pub. Date: Jun. 22, 2006

(54) Matt, biaxially oriented polyester film

(76) Inventors: Martin Jesberger, Mainz (DE); Matthias Konrad, Hofheim (DE); Thorsten Kiehne, Shiga (JP); Ursula Murschall, Nierstein (DE)

Correspondence Address: PROPAT, L.L.C., 425-C SOUTH SHARON AMITY ROAD, CHARLOTTE, NC, 28211-2841, US

(21) Appl. No.: 11/285,131

(22) Filed: Nov. 22, 2005

(30) Foreign Application Priority Data
Dec. 21, 2004 (DE) 10 2004 061 390.7

(51) Int. Cl. G11B 5/64

(52) U.S. Cl. 428/141

(57) ABSTRACT

The invention relates to a single- or multilayer, biaxially oriented polyester film where at least one layer includes an amount of from 0.2 to <1.0 % by weight, based on the total weight of the film, of silicon dioxide particles whose median particle size, d₅₀ is from 2.5 to 4.5 μm. The inventive films have particular suitability in the industrial sector, e.g. for greenhouses, for more diffuse light-scattering.

### CROSS-REFERENCE TO RELATED APPLICATIONS

This application claims priority to parent German Patent Application No. 10 2004 061 390.7, filed Dec. 21, 2004, hereby incorporated by reference herein in its entirety.

### FIELD OF THE INVENTION

The invention relates to a single- or multilayer, matt, biaxially oriented polyester film which comprises a total particle concentration of from 0.2 to <1.0 % by weight (based on the weight of the film) of SiO₂ particles whose median particle size (d₅₀) is from 2.5 to 4.5 μm. The invention further relates to a process for the production of the film and to its use.

### BACKGROUND OF THE INVENTION

There is a high level of industrial demand for plastics films, e.g. biaxially oriented polypropylene films or biaxially oriented polyester films, where these have defined surfaces and optical properties. Films with uniform surface roughness which is not excessively high are of interest in specific applications. In particular, use as greenhouse films demands a combination of high haze with simultaneous high transparency. It is particularly difficult to comply with this requirement because these two parameters are inversely correlated. Although it is possible to raise the haze via incorporation of particles, the transparency also consequently becomes lower, this being undesirable. The solution of this problem was not trivial.

The inventive film features characteristic optical properties. The high haze of the film increases the proportion of scattered light. The simultaneously high transparency of the film improves the growth of the plants by way of example when it is used as a greenhouse film and thus increases the cost-effectiveness of cultivation of the plants. The increased arithmetic roughness Rₐ makes it easier to process the film during the production process. The film also has good suitability in the industrial sector, alongside its use as greenhouse film.

U.S. Pat. No. 3,154,461 describes a process for production of a biaxially oriented film composed of thermoplastic (e.g. polyethylene terephthalate, polypropylene) with a matt surface, in which the film comprises incompressible particles (e.g. calcium carbonate, silicon dioxide) whose size is from 0.3 to 20 μm and whose concentration is from 1 to 25%. The film produced by that process is too rough for many applications.

EP-A-1 197 326 describes a matt, biaxially oriented polyester film which comprises from 1 to 10% by weight of particles whose median particle size is from 2 to 5 μm. The average roughness Rₐ of these films is in the range from 150 to 1000 nm.

EP-A-0 152 265 describes a polyester film which comprises from 0.01 to 1.0% by weight of silicon dioxide and/or titanium dioxide whose median particle size is from 0.01 to 0.5 μm, and from 0.02 to 0.5% by weight of calcium carbonate whose median particle size is from 0.04 to 0.48 μm. The small particles give this film very low roughness, but nothing is said concerning transparency.

### SUMMARY OF ADVENTAGEOUS EMBODIMENTS OF THE INVENTION

It was an object of the present invention to provide a biaxially oriented polyester film which has uniform roughness and defined optical properties. The structure of the surface is intended to give the film good coatability.

### BRIEF DESCRIPTION OF THE FIGURES

FIG. 1 is an exemplary cumulative particle size distribution curve.

### DETAILED DESCRIPTION OF ADVENTAGEOUS EMBODIMENTS OF THE INVENTION

According to the invention, the object is achieved via a single- or multilayer, matt, biaxially oriented polyester film, where at least one layer comprises silicon dioxide to generate surface roughness and to adjust haze at high transparency. The concentration of the silicon dioxide is from 0.2 to <1.0% by weight, preferably from 0.4 to 0.9% by weight, particularly preferably from 0.6 to 0.8% by weight, based on the total weight of the film. If necessary, the film can moreover also comprise a UV absorber. Triazines, e.g. TINUVIN® 1577 from Ciba, Basle, Switzerland, are preferably used as UV absorbers here.

The inventive film preferably has the following properties:
The haze of the film is in the range from 38 to 60%, preferably from 40 to 58%, and particularly preferably from 42 to 56%; the transparency of the film is preferably simultaneously in the range from 70 to 95%, preferably from 80 to 92%, and particularly preferably from 82 to 90%.
The size of the SiO₂ particles is smaller than or equal to 4.5 μm, preferably smaller than or equal to 4.0 μm, and particularly preferably smaller than or equal to 3.9 μm (d₅₀) and greater than 2.5 μm, preferably greater than 2.8 μm, and particularly preferably greater than 3.0 μm. The silicon dioxide is preferably amorphous silica.
The gloss of the film, measured at 60° and 85°, is from 10 to 100 at both measurement angles, preferably from 15 to 85, and particularly preferably from 20 to 70.
The arithmetic average roughness value Rₐ (DIN 4762) is from 170 to 1000 nm, preferably from 180 to 950 nm, and particularly preferably from 200 to 800 nm.

According to the invention, the film preferably has a single-layer structure and in this case its only layer is the base layer (B).

The base layer (B) of the film preferably comprises at least 70% by weight of thermoplastic polyester. Polyesters suitable for this are those made from ethylene glycol and terephthalic acid (polyethylene terephthalate, PET), from ethylene glycol and naphthalene-2,6-dicarboxylic acid (polyethylene 2,6-naphthalate, PEN), from 1,4-bishydroxymethylcyclohexane and terephthalic acid [poly-1,4-cyclohexanedimethylene terephthalate, PCDT] or from ethylene glycol, naphthalene-2,6-dicarboxylic acid and biphenyl-4,4′-dicarboxylic acid (polyethylene 2,6-naphthalate bibenzoate, PENBB). Particular preference is given to polyesters which are composed to an extent of at least 90 mol %, preferably at least 95 mol %, of ethylene glycol and terephthalic acid units or of ethylene glycol and naphthalene-2,6-dicarboxylic acid units. The remaining monomer units are derived from other aliphatic, cycloaliphatic or aromatic diols and dicarboxylic acids listed at a later stage below. In one particularly preferred embodiment, the base layer is composed of polyethylene terephthalate homopolymer.

Examples of other suitable aliphatic diols are diethylene glycol, triethylene glycol, aliphatic glycols of the formula HO—(CH₂)ₙ—OH, where n is an integer from 3 to 6, (in particular 1,3-propanediol, 1,4-butanediol, 1,5-pentanediol and 1,6-hexanediol), or branched aliphatic glycols having up to 6 carbon atoms. Of the cycloaliphatic diols, cyclohexanediols (in particular 1,4-cyclohexanediol) should be mentioned. Examples of other suitable aromatic diols are those of the formula HO—C₆H₄—X—C₆H₄—OH, where X is —CH₂—, —C(CH₃)₂—, —C(CF₃)₂—, —O—, —S— or —SO₂—. Besides these, bisphenols of the formula HO—C₆H₄—C₆H₄—OH are also very suitable.

Other preferred aromatic dicarboxylic acids are benzenedicarboxylic acids, naphthalenedicarboxylic acids (for example naphthalene-1,4- or -1,6-dicarbox-ylic acid), biphenyl-x,x′-dicarboxylic acids (in particular biphenyl-4, 4′-dicarboxylic acid), diphenyl-acetylene-x,x′-dicarboxylic acids (in particular diphenylacetylene-4,4′-dicarboxylic acid) and stilbene-x,x′-dicarboxylic acids. Of the cycloaliphatic dicarboxylic acids, mention should be made of cyclohexanedicarboxylic acids (in particular cyclo-hexane-1,4-dicarboxylic acid). Particularly suitable aliphatic dicarboxylic acids are the C₃-C₁₉ alkanedioic acids, the alkane part of which may be straight-chain or branched.

The additional layer(s) (intermediate or outer layers) present, if appropriate, in the film are likewise preferably composed of the polyester described above for the base layer, the constitution here being identical with or different from that of the base layer.

The polyesters may be prepared by the transesterification process, the starting materials for which are dicarboxylic esters and diols, which are reacted using the customary transesterification catalysts, such as salts of zinc, calcium, lithium, magnesium and manganese. The intermediates are then polycondensed in the presence of widely used polycondensation catalysts, such as antimony trioxide or titanium salts. The preparation may be carried out just as successfully by the direct esterification process in the presence of polycondensation catalysts, starting directly from the dicarboxylic acids and the diols.

The film according to the invention comprises SiO₂ particles to generate the desired surface properties and optical properties.

The particle concentration, based on the total weight of the film, is from 0.2 to <1.0% by weight, preferably from 0.4 to 0.9% by weight, particularly preferably from 0.6 to 0.8% by weight. If the amount present is less than 0.2% by weight, the haze becomes less than 38%. If the amount of particles present is 1.0% by weight or more, the haze becomes greater than 60%. The median particle size of the SiO₂ particles is preferably from 2.5 to 4.5 μm, preferably from 2.8 to 4.2 μm, and particularly preferably from 3.0 to 3.9 μm (d₅₀). If the size of the particles is greater than 4.5 μm, for an identical SiO₂ concentration, the haze becomes greater, with a simultaneous decrease in the transparency. If the size of the particles is smaller than 2.5 μm, for identical SiO₂ concentration, the haze becomes lower and the transparency becomes higher. The silicon dioxide particles used are preferably amorphous silica particles.

It is surprising here that the arithmetic average roughness value Rₐ (DIN 4762) is from 170 to 1000 nm, preferably from 180 to 950 nm, and particularly preferably from 200 to 800 nm. The relatively high roughness makes the film less susceptible to blocking and improves winding in the industrial process. If smaller particles are used, for an identical SiO₂ concentration, Rₐ and the haze are lowered.

Another effect of the selected type, concentration, and particle size of the SiO₂ particles is that the transparency of the film is from 70 to 95%, preferably from 80 to 92%, and particularly preferably from 82 to 90%, and the haze of the film is in the range from 38 to 60%, preferably from 40 to 58%, and particularly preferably from 42 to 56%, and the gloss of the film, measured at 60° and 85° is from 10 to 100 at both measurement angles, preferably from 15 to 85, and particularly preferably from 20 to 70.

The inventive film preferably comprises, other than the SiO₂ particles described above, no other particles which affect, or which can affect, the surface properties and/or optical properties of the film, e.g. CaCO₃ particles, TiO₂ particles, BaSO₄ particles, etc. If necessary, conventional stabilizers can also be present, e.g. phosphorus compounds, such as phosphoric acid or phosphoric esters, which derive from the production of the polyester, and which are usually termed “internal” particles or (catalyst) precipitates.

It has moreover proven advantageous for the inventive film also to comprise from 0 to 10% by weight, preferably from 1 to 8% by weight, particularly preferably from 2 to 6% by weight, of a UV absorber. UV absorbers preferably used here are triazines, e.g. TINUVIN® 1577 from Ciba, Basle, Switzerland. The use of the UV absorber permits better weathering resistance, inhibits film-lifetime reduction by UV radiation, and gives the film good suitability for exterior applications, e.g. use as greenhouse film.

The thickness of the inventive polyester film can vary within certain limits. It is advantageously in the range from 3 to 250 μm, in particular from 4 to 100 μm, preferably from 5 to 50 μm.

Production process:

The invention also provides a process for production of the inventive polyester film, by the extrusion process known from the literature (see, for example: “Handbook of Thermoplastic Polyesters, Ed. S. Fakirov, Wiley-VCH, 2002” or in the chapter “Polyesters, Films” in “Encyclopedia of Polymer Science and Engineering, Vol. 12, John Wiley & Sons, 1988”).

For the purposes of this process, the procedure is that the melt corresponding to the film is extruded through a flat-film die, the resultant film is drawn off for solidification on one or more rolls, the film is then biaxially stretched (oriented), the biaxially stretched film is heat-set and, if appropriate, also corona- or flame-treated on the surface layer intended for treatment.

The biaxial stretching (orientation) process is generally carried out sequentially, preference being given to the sequential biaxial stretching process which usually begins with longitudinal stretching (in machine direction) and then proceeds to transverse stretching (perpendicularly to machine direction).

First, as is usual in the extrusion process, the polymer or the polymer mixture for the film is compressed and plasticized in an extruder, and any additives, such as particles, which are intended additions may by this stage be present in the polymer or in the polymer mixture. The melt is then simultaneously extruded through a flat-film die (slot die), and the extruded melt is drawn off on one or more cooled take-off rolls, whereupon the melt cools and solidifies to give a prefilm.

The biaxial orientation is generally carried out sequentially. For this, it is preferable to orientate firstly in a longitudinal direction (i.e. in the machine direction) and then in a transverse direction (i.e. perpendicularly to the machine direction) . This causes an orientation of the polymer chains. The orientation in a longitudinal direction may be carried out with the aid of two rolls running at different speeds corresponding to the stretching ratio to be achieved. For the transverse orientation, use is generally made of an appropriate tenter frame, in which both edges of the film are clamped and then drawn toward the two sides at an elevated temperature.

The temperature at which the orientation is carried out can vary over a relatively wide range and depends on the film properties desired. In general, the longitudinal stretching is carried out at from 80 to 130° C., and the transverse stretching at from 80 to 150° C. The longitudinal stretching ratio is generally in the range from 2.5:1 to 6:1, preferably 3:1 to 5.5:1. The transverse stretching ratio is generally in the range from 3.0:1 to 5.0:1, preferably from 3.5:1 to 4.5:1.

In the subsequent heat-setting, the film is held for from 0.1 to 10 s at a temperature of from 150 to 250 ° C. The film is then wound up in the usual manner.

After the biaxial stretching process, one or both surfaces of the film may be corona- or flame-treated by one of the known methods. The intensity of treatment is selected so that the surface tension of the film is generally greater than 45 mN/m.

The film may also be coated to establish other desired properties. Typical coatings are those which promote adhesion, are antistatic, improve slip or have release action. Clearly, these additional layers can be applied to the film by way of in-line coating by means of aqueous dispersions after the longitudinal stretching step and prior to the transverse stretching step.

During production of the inventive film, an amount in the range from 20 to 70% by weight, based on the total weight of the film, of the cut material (regrind) can be reintroduced into the extrusion process with no significant resultant adverse effect on the physical properties of the film, in particular on its appearance.

The inventive film is distinguished by defined optical properties and uniform roughness. Table 1 below gives the properties of the inventive films.

TABLE 1

| Film | | | | | |
|---|---|---|---|---|---|
| proper- | Inventive | | Particularly | | Test |
| ties | range | Preferred | preferred | Unit | method |
| SiO₂ | 0.2-<1.0 | 0.4-0.9 | 0.6-0.8 | % by | |
| content | | | | wt. | |
| SiO₂ | 2.5-4.5 | 2.8-4.0 | 3.0-3.9 | μm | |
| particle | | | | | |
| size (d₅₀) | | | | | |
| Trans- | 70-95 | 80-92 | 82-90 | % | ASTM |
| parency | | | | | D1003-00 |
| 60° gloss | 10-100 | 15-85 | 20-70 | | DIN |
| | | | | | 67 530 |
| 85° gloss | 10-100 | 15-85 | 20-70 | | DIN |
| | | | | | 67 530 |
| Haze | 38-60 | 40-58 | 42-56 | % | ASTM |
| | | | | | D1003-00 |
| Arithmetic | 170-1000 | 180-950 | 200-800 | nm | DIN |
| average | | | | | 4762 |
| roughness | | | | | |
| Rₐ | | | | | |
| Thickness | 3-250 | 4-100 | 5-50 | μm | |
| UV | 0-10 | 1-8 | 2-6 | % by | |
| absorber | | | | wt. | |

The optical properties of the inventive films give them particular suitability in the industrial sector, e.g. for greenhouses, for more diffuse light-scattering. This increases the growth rate of the plants and leads to improved cost-effectiveness. If a UV absorber is used, weathering resistance becomes greater, and with this the lifetime of the film.

For the purposes of the present invention, the following test methods were utilized to characterize the raw materials and the films:

Roughness

The arithmetic average roughness value Rₐ was determined to DIN 4762.

Gloss

Gloss was determined to DIN 67 530. Reflectance was measured, this being a characteristic optical variable for a film surface. Using a method based on the standards ASTM D523-78 and ISO 2813, the angle of incidence was set at 60° or 85°. A beam of light hits the flat test surface at the set angle of incidence and is reflected and/or scattered by the surface. A proportional electrical variable is displayed, representing the light rays hitting the photoelectric detector. The value measured is dimensionless and has to be stated together with the angle of incidence.

Measurement of Median Diameter d₅₀

Median diameter d₅₀was determined by means of a laser on a Malvern Mastersizer by the standard method (examples of other test equipment being the Horiba LA 500 or Sympathec Helos, which use the same principle of measurement) . For this, the specimens were placed with water in a cell and the cell was then placed in the test equipment. The test procedure is automatic and also includes mathematical determination of the d₅₀value.

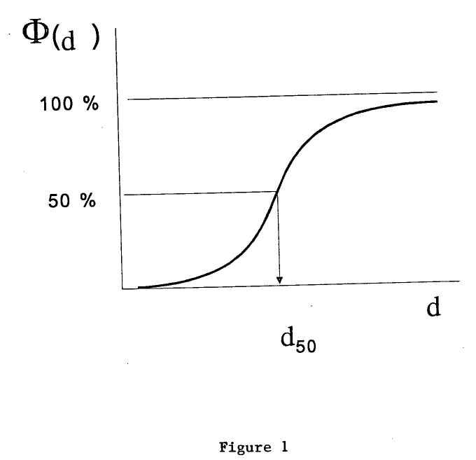

The d₅₀value is defined here as being determined from the (relative) cumulative curve of particle size distribution: the intersect of the 50% ordinate value with the cumulative curve directly gives the desired d₅₀value on the abscissa axis. FIG. 1 explains this in further detail.

Transparency and Haze

The polyester films are tested on the BYK Gardner XL-211 Hazegard hazemeter, to ASTM D1003-00.

Examples are used below for further illustration of the invention.

### EXAMPLE 1

Chips composed of polyethylene terephthalate were introduced at a temperature of 150° C. into the extruder or the base layer (B) . A single-layer film with total thickness of 20 μm was then produced via extrusion and subsequent stepwise longitudinal and transverse orientation.

The film was a mixture composed of:
75% by weight of polyethylene terephthalate whose SV value was 750
25% by weight of masterbatch composed of 96% by weight of polyethylene terephthalate, 3.0% by weight of silica particles whose d₅₀value was 3.5 μm, and 1.0% by weight of UV absorber TINUVIN® 1577 from Ciba, Switzerland.

The production conditions in the individual steps of the process were:

| | | |
|---|---|---|
| Extrusion: | Temperature | 290° C. |
| | Temperature of take-off | 30° C. |
| | rolls | |
| Longitudinal | Temperature: | from 80 to 126° C. |
| stretching: | Longitudinal stretching | 3.5 |
| | ratio: | |
| Transverse | Temperature: | from 80 to 135° C. |
| stretching: | Transverse stretching | 4.0 |
| | ratio: | |
| Setting: | Temperature: | 230° C. |
| | Duration: | 3 s |

The film had the required haze and transparency. The properties achieved in the film are given in table 2.

### EXAMPLE 2

The changes to the constitution of the film, compared with Example 1, were as follows:

The film was a mixture composed of:
67% by weight of polyethylene terephthalate whose SV value was 750
33% by weight of masterbatch composed of 96% by weight of polyethylene terephthalate, 3.0% by weight of silica particles whose d₅₀value was 3.5 μm, and 1.0% by weight of UV absorber TINUVIN® 1577 from Ciba, Switzerland.

Compared with Example 1, there was an increase of 12 percentage points in the haze of the film, a reduction of 1 percentage point in the transparency, and an increase of 34 nm in the arithmetic roughness Rₐ. The properties achieved in the film are given in Table 2.

### EXAMPLE 3

The changes to the constitution of the film, compared with Example 1, were as follows:

The film was a mixture composed of:
83% by weight of polyethylene terephthalate whose SV value was 750
17% by weight of masterbatch composed of 96% by weight of polyethylene terephthalate, 3.0% by weight of silica particles whose d₅₀value was 3.5 μm, and 1.0% by weight of UV absorber TINUVIN® 1577 from Ciba, Switzerland.

Compared with Example 1, there was a reduction of 12 percentage points in the haze of the film, an increase of 2 percentage points in the transparency, and a reduction of 49 nm in the arithmetic roughness Rₐ. The properties achieved in the film are given in Table 2.

### COMPARATIVE EXAMPLE 1

When comparison was made with Example 1, a different particle system was now used to modify the film. The haze of the film was too low, as was the arithmetic roughness Rₐ.

The film was a mixture composed of:
75% by weight of polyethylene terephthalate whose SV value was 750
25% by weight of masterbatch composed of 96% by weight of polyethylene terephthalate, 3.0% by weight of silica particles whose d₅₀value was 2.4 μm, and 1.0% by weight of UV absorber TINUVIN® 1577 from Ciba, Switzerland.

The properties achieved in the film are given in table 2.

### COMPARATIVE EXAMPLE 2

Comparative Example 2 was taken from EP-A-1 197 326 (Example 1). The transparency of the film was too low.

TABLE 2

| | Film | SiO₂ | SiO₂ | | | | |
|---|---|---|---|---|---|---|---|
| | thick- | diameter | concen- | | Rough- | Trans- | Gloss |
| Exam- | ness | in film | tration | Haze | ness Rₐ | parency | at |
| ple | [μm] | [μm] | [%] | [%] | [nm] | [%] | 60°/85° |
| E 1 | 20 | 3.5 | 0.75 | 50 | 261 | 85 | 49/53 |
| E 2 | 20 | 3.5 | 0.99 | 62 | 295 | 84 | 38/48 |
| E 3 | 20 | 3.5 | 0.51 | 38 | 212 | 87 | 63/65 |
| CE 1 | 20 | 2.4 | 0.75 | 31 | 148 | 87 | 63/77 |
| CE 2 | 23 | 3.4 | 5.00 | 65 | 230 | 69 | 35/45 |

1. A single- or multilayer, biaxially oriented polyester film comprising at least one layer, said at least one layer comprising an amount of from about 0.2 to <1.0% by weight, based on the total weight of the film, of silicon dioxide particles whose median particle size, d₅₀, is from about 2.5 to 4.5 μm.

2. The film as claimed in claim 1, whose haze is in the range from about 38 to 60% and whose transparency is simultaneously in the range from about 70 to 95%, both values measured to ASTM D1003-00.

3. The film as claimed in claim 1, said film exhibiting gloss, measured at 60° and 85° to DIN 67 530, of from about 10 to 100 at both measurement angles.

4. The film as claimed in claim 1, wherein the arithmetic average roughness value Rₐ, measured to DIN 4762, of at least one surface of the film is from about 170 to 1000 nm.

5. The film as claimed in claim 1, wherein said film is a single-layer film.

6. The film as claimed in claim 1, wherein said film further comprises a UV stabilizer.

7. The film as claimed in claim 1, which comprises no further particles, other than catalyst precipitates.

8. The film as claimed in claim 1, wherein the silicon dioxide particles are amorphous silica particles.

9. The film as claimed in claim 1, wherein said film has a thickness ranging from about 3 to 250 μm.

10. A process for producing a film as claimed in claim 1, said process comprising melting a polyester polymer in at least one extruder and either introducing the resultant polymer melt corresponding to the constitution of the film layer into a die, or introducing the resultant polymer melts corresponding to the constitutions of the outer and base layers into a coextrusion die, extruding the material from the die onto a chill roll, biaxially stretching the resultant prefilm and heat setting the biaxially stretched film, wherein the polymer melt(s) for the base layer and/or for the outer layer(s) comprise an amount of from about 0.2 to <1.0% by weight of silicon dioxide particles whose median particle size, d₅₀, is from about 2.5 to 4.5 μm.

11. Industrial film comprising film as claimed in claim 1.

12. Green house film comprising film as claimed in claim 1.

13. Outdoor film comprising film as claimed in claim 1.
